(19) United States
(12) Patent Application Publication
(10) Pub. No.: US 2011/0266947 A1
(43) Pub. Date: Nov. 3, 2011

(54) CERAMIC GAS DISCHARGE METAL HALIDE LAMP

(75) Inventor: Junming Tu, Bath, NY (US)

(73) Assignee: KONINKLIJKE PHILIPS ELECTRONICS N.V., Eindhoven (NL)

(21) Appl. No.: 13/142,607

(22) PCT Filed: Dec. 4, 2009
(86) PCT No.: PCT/IB2009/055529

§ 371 Date: Jun. 29, 2011

Related U.S. Application Data
(60) Provisional application No. 61/141,279, filed on Dec. 30, 2008.

(51) Int. Cl. H01J 61/20; H01J 61/12; H01J 61/04

(52) U.S. Cl. 313/573; 313/641; 313/620

(57) ABSTRACT

A ceramic gas discharge metal halide (CDM) lamp (10) capable of retrofitting into existing high pressure iodide (HPI) metal halide and high pressure mercury vapor (HP) lamp fixtures for significient energy savings, the CDM lamp (10) having a ceramic discharge vessel (12) containing a pair of discharge electrodes (17, 18), a Penning mixture of the rare gases neon and argon, and a chemical fill which includes an oxygen dispenser and which restricts strong oxygen binders to 5 mole percent or less. In a preferred embodiment, the discharge vessel (12) has an aspect ratio R of less than 2, a wall thickness t of up to 1.2 mm, a spacing d between the discharge electrodes (17, 18) of up to 14 mm, and a passive antenna (26) on the outer wall of the discharge vessel (12), with the shortest distance a between a discharge electrode (17, 18) and the floating antenna (26) of up to 7 mm.

### BACKGROUND OF THE INVENTION

This invention generally relates to ceramic gas discharge metal halide (CDM) lamps, and, more particularly, relates to such lamps which utilize a polycrystalline alumina (PCA) ceramic discharge vessel and a starting mixture of rare gases in the discharge space.

Recently, increasing demand for reserving natural resources has led to a demand for higher efficacy lighting and lamps. For example, new energy regulations in China require a minimum efficacy of 90 lumens per watt for metal halide (MH) lamps.

The High Pressure Iodide (HPI) metal halide lamp, which has been in the market for over forty years, offers white light and long life and thus has multiple lighting applications. It is especially popular in Europe and Asia. However, the efficacy of HPI lamps is in the moderate range of 80 lumens per watt. The efficacy of high pressure mercury vapour (MV or HP) lamp is even lower (e.g., 57.5 lumens per watt for clear lamps and 45 lm/W for phosphor-coated 400 W lamps).

CDM lamps employ a highly stable discharge vessel of polycrystalline alumina (PCA), which enables the use of special metal halide salt mixtures designed to produce an emission spectrum of light radiation close to that of natural light. The lamps can also operate at higher temperatures and have much higher lumen outputs and much improved color properties and thus and thus have higher efficacy than the HPI and HP lamps and thus their use can result in significant energy savings.

U.S. Pat. No. 6,833,677 discloses a ceramic gas discharge metal halide (CDM) lamp having a power of from 150 W to 1000 W. These lamps can retrofit into high pressure sodium (HPS) or pulse start quartz metal halide (QMH) sockets, but are not suitable retrofits for HPI or HP lamps. This is because the HPI and HP lamps operate on ballasts that are typically reactor or constant wattage autotransformer (CWA) ballasts without the high voltage pulses (e.g., 3 kV to 4 kV) provided by an ignitor. Moreover, the open circuit voltage (OCV) for these less expensive ballasts is lower than for those ballasts designed to operate quartz metal halide (MH) lamps (˜240V OCV for HPI/HP ballasts and ˜300V for MH ballasts). Igniting the lamps, according to U.S. Pat. No. 6,833,677 on these ballasts requires high voltage pulses (>3 kV) provided by an ignitor.

U.S. Pat. No. 6,833,677 employs a starting gas of 99.99 percent xenon, with a trace amount of radioactive krypton (Kr⁸⁵) in the discharge vessel of the CDM lamp in order to enhance reliable ignition. The use of xenon gas is intended to suppress tungsten sputtering from the electrodes during starting and normal operation, and to reduce wall blackening due to the large xenon atom size. However, the use of xenon gas tends to increase the lamp ignition voltage. Thus, the lamp disclosed in that patent has to operate on a ballast that has voltage pulses higher than 3 kV for reliable starting.

Some lamps use argon-krypton⁸⁵ as a starting gas instead of xenon-krypton⁸⁵. The advantage of argon gas is that it forms a so-called Penning mixture (a mixture of one inert gas with a tiny amount of another gas that has lower ionization voltage than the main constituent) between argon and mercury, another component present in the discharge vessel. The Penning mixture reduces the ignition voltage significantly. With argon gas inside the discharge vessel, the lamp ignition voltage is much lower than is the case with xenon gas. Thus, lamps with argon gas are candidates for retrofit applications in lamp systems employing ballasts without an ignitor.

The disadvantage of argon gas is that argon atoms are smaller than xenon atoms, and thus argon is not as good as xenon in suppressing tungsten sputtering from the electrodes, and preventing tungsten atoms from reaching the walls of the discharge vessel. As a result, wall blackening occurs and lumen maintenance is lower for argon-filled lamps as compared to xenon-filled lamps. It is known that a neon-argon Penning mixture has about 8 times lower ignition voltage than pure argon gas (John Waymouth, Electric Discharge lamps, The M.I.T. Press Figure 3.10, p 64-p 65). However, this mixture of predominately light atoms of neon is even less efficient than pure argon in suppressing tungsten sputtering, and thus the lumen maintenance for lamps filled with light gases such as the neon-argon Penning mixture is even lower than that of lamps employing the heavier atoms argon and xenon.

U.S. Pat. No. 6,362,571 discloses a CDM lamp characterized in that the ionizable filling in the discharge vessel contains an oxygen dispenser and is free from rare-earth halides. The oxygen dispenser contains CaO, which improves the color rendition of the lamp, and also counteracts wall blackening, while the absence of rare earth halides means less corrosion of the walls of the discharge vessel.

### SUMMARY OF THE INVENTION

In its various embodiments and implementations, the present invention focuses on a CDM lamp having a discharge vessel which employs a starting gas mixture of neon and argon, and a chemical fill which includes an oxygen dispenser and no more than about 5 mole percent of rare earth halides (e.g., iodides) or other strong oxygen binders, such as scandium halides and yttrium halides.

The presence of the oxygen dispenser together with the limited amount of strong oxygen binders enables a process known as tungsten re-generation to occur in the discharge vessel during lamp operation. The process is enabled when sufficient vapour pressure of WO₂I₂ exists near the wall of the discharge vessel to prevent tungsten crystal growth on the wall. At the high temperatures generated by the plasma stream of the arc discharge, WO₂I₂ decomposes and tungsten deposits back onto the electrodes. As a result, the discharge wall remains clean, and the lumen maintenance for the lamp is not negatively affected by the presence of the relatively light gas mixture of neon-argon.

In its broadest aspect, the invention is embodied in a CDM lamp having a ceramic discharge vessel enclosing a discharge space, the discharge space filled with a rare gas starting mixture, a metal halide mixture and mercury, characterized in that the rare gas mixture is a mixture of neon and argon, further characterized in that the discharge space contains an oxygen dispenser, the oxygen dispenser containing calcium oxide (CaO). CaO is advantageous in that it forms part of the filling of the discharge vessel. The invention is further characterized in that the presence of strong oxygen binders such as the rare earth halides, scandium halides and yttrium halides in the discharge space is strictly limited.

Preferably, the rare gas mixture is a Penning mixture of from about 95 to 99.8 mole percent neon, remainder argon, preferably from about 98 to about 99.8 mole percent neon and from about 0.2 to about 2 mole percent argon. Also, preferably, the oxygen dispenser containing CaO is in the form of a ceramic CaO-impregnated carrier. The combined total of strong oxygen binders is limited up to about 5 mole percent, preferably up to about 3 mole percent.

Because of the formation of efficient Penning mixtures between neon and argon, the lamp can start at much lower voltage provided by a ballast without an ignitor. Unlike the argon-mercury mixture that relies on Hg pressure which has very low vapour pressure at low temperature, the neon-argon Penning mixture is not affected by low temperature. So the neon-argon gas filled lamp can reliably start at cold and dark environment.

For reliable starting at the extreme conditions, a trace of radioactive gas such as Kr⁸⁵ is preferable.

According to a particular embodiment of the invention, the discharge tube has particular design features including: a starting gas fill pressure, a passive starting electrode outside the discharge vessel, an aspect ratio R, a wall thickness t, and the distance a between the discharge electrodes and the starting electrode, which enable lamp starting in the older type of magnetic ballasts without high voltage pulses (>3 kV) which were designed for HPI and HP lamps. According to this embodiment of the invention, the fill pressure is between 40 mbar to 250 mbar, preferably between 60 mbar to 150 mbar. If the pressure is too low, it will be difficult to eliminate the hydrogen iodide voltage spikes that could make the lamps cycle out during run-up. If the pressure is too high, on the other hand, it will become difficult to start the lamp because the high pressure increases the ignition voltage.

Also according to this embodiment, the passive starting electrode, also called a floating antenna or starting aid, is made of tungsten, molybdenum or other compatible metal or alloy, is mounted on the external surface of the discharge vessel or sintered onto the discharge vessel. An electric field will be generated between the electrode and the floating antenna even though the antenna does not electrically connect to any of the lamp's internal or external circuitry. Further, the aspect ratio R, defined as the ratio of the internal length (IL) and the internal diameter (ID) of the discharge vessel (R=IL:ID) is preferably smaller than 2, preferably smaller than 1.5, in order to achieve a short distance d between the discharge electrodes for reliable ignition. Based on Paschei's law, the starting voltage U is a direct function of the cold gas filling pressure p and the electrode distance d[U=f(p*d)]A, according to which a shorter electrode distance d will reduce the ignition voltage.

Also according to this embodiment, the discharge vessel shape is designed in such a way that the distance a between the discharge electrode and the antenna is less than about 7 mm, preferably less than about 5 mm, for reliable ignition. The wall thickness should be less than 1.2 mm, preferably less than 1.0 mm, for the same reason.

The distance d between the discharge electrodes is preferably shorter than the typical distance for lamps operating on the ballasts with ignitor. For example, for a 400 W CDM lamp of this embodiment of the invention, the distance d should be less than about 14 mm, preferable less than about 12 mm. For a 250 W CDM lamp of this embodiment of the invention, the distance d should be preferable less than about 10 mm.

A CDM lamp according to various embodiments of the invention exhibits very reliable ignition characteristics. For example, such a lamp can start at −10 percent rated power at room temperature, as well as in a dark and cold box at −30° C. According to the invention, such a CDM lamp is suitable for retrofitting high pressure iodide (HPI), metal halide and high pressure mercury vapour (HP) systems that operate on conventional magnetic ballast systems.

### BRIEF DESCRIPTION OF THE DRAWINGS

These and other aspects of the invention will be further elucidated with reference to the Figures, in which:

FIG. 1 shows a medium wattage ceramic gas discharge metal halide (CDM) lamp with a neon-argon rare gas fill and with an antenna, being capable of operating on a ballast without a high voltage pulse (ignitor) according to one embodiment of the invention; and

FIG. 2 shows a shaped discharge vessel for use in a CDM lamp of the type shown in FIG. 1.

The Figures are diagrammatic and not drawn to scale. The same reference numbers in different Figures refer to like parts.

### DETAILED DESCRIPTION OF THE PREFERRED EMBODIMENTS

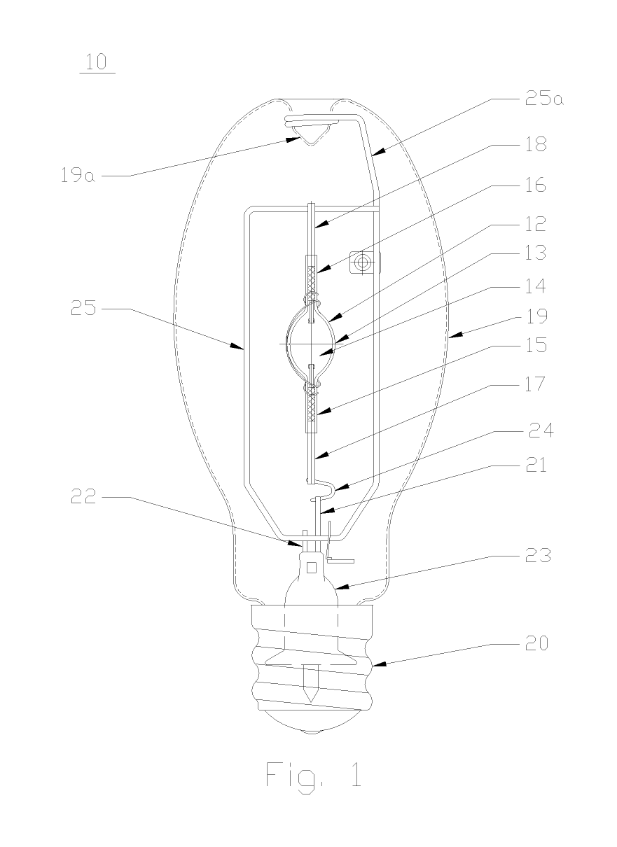

FIG. 1 shows a CDM lamp 10 having a PCA discharge vessel 12 including a central elliptically-shaped portion 13 enclosing a discharge space 14, and a pair of tube-shaped end portions 15 and 16. A pair of discharge electrodes 17 and 18 extend through and are supported by the end portions 15 and 16 of the discharge vessel 12 into the discharge space 14. An outer bulb-shaped envelope 19 surrounds the discharge vessel 12 and discharge electrodes 17 and 18 and is sealed to a metal screw base 20 to provide an air-tight enclosure.

Electrical leads 21 and 22 are electrically connected to base 20 and extend through and are supported by glass press seal 23. Electrical connection between discharge electrode 17 and external electrical lead 21 is provided by supporting element 24, while electrical connection between discharge electrode 18 and external electrical lead 22 is provided by a supporting frame member 25. A clearance (not shown in FIG. 1) is provided between electrical lead 21 and frame member 25 in order to prevent shorting out of the internal lamp circuit. An extension 25a of frame member 25 wraps around a dimple 19a extending inwardly from the upper end of envelope 19 to provide additional support.

The discharge space 14 is filled with a starting gas of a mixture of rare gases and a chemical filling of metal halide salts chosen from sodium, calcium, magnesium, indium, manganese, thallium, the rare earths, and mercury.

According to various embodiments of the invention, the chemical filling contains a low amount of strong oxygen binders such as the halides of the rare earths, scandium and yttrium, and an oxygen dispenser in a sufficient amount to realize a tungsten re-generation cycle within the discharge space 14 during lamp operation, resulting in a satisfactory lumen maintenance.

In this regard, it has been found that oxygen dispenser in an amount to result in a WO₂I₂ pressure within the discharge vessel of from about 1×10⁻⁵ bar to about 1×10⁻¹⁰ bar is sufficient to realize a tungsten re-generation cycle. Below this range, wall blackening will occur and lumen maintenance will be reduced, while above this range, lamp life could be shortened due to severe erosion or breakage of the tungsten discharge electrodes.

The starting gas mixture is a Penning mixture of neon and argon, about 95 to 99.8 mole percent neon, preferably about 98 to 99.8 mole percent neon, and about 0.2 to 2 mole percent argon. According to the particularly preferred embodiment, the fill pressure is in the range of about 40 mbar to about 250 mbar, preferably from about 60 mbar to about 150 mbar. If the pressure is too low, it will be difficult to eliminate hydrogen iodide voltage spikes. If the pressure is too high, on the other hand, it will become difficult to start the lamp because the high pressure increases the ignition voltage.

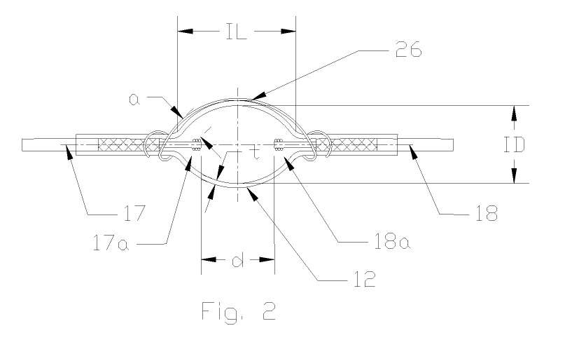

According to one particularly preferred embodiment of the invention, a floating antenna 26, as shown in FIG. 2, is attached to the outside wall of the discharge vessel 12. The antenna can assist in starting of the lamp, due to the generation of an electric field between the antenna and the discharge electrodes 17 and 18, even though the antenna does not connect to any electrically conducting lead. The shortest distance a between antenna 26 and one of the discharge electrodes 17 and 18 should be less than about 7 mm, preferably less than about 5 mm. The floating antenna 26 in FIG. 2 is in the form of a wire, but could also be in the form of a strip or layer, and could be made of tungsten, molybdenum or other compatible metal, and could be mounted on, sintered to or otherwise attached to the external surface of the discharge vessel 12. In some embodiments, the aspect ratio R of the discharge vessel 12 is smaller than about 2, preferably smaller than about 1.5, to achieve a short electrode distance d and reliable ignition.

### Example 1

In order to demonstrate some advantages of the invention, two sets of medium wattage (400 W) CDM lamps (with and without antennas) were fabricated for testing, having fills of starting gas of argon and a trace amount of radioactive krypton⁸⁵ according to the prior art and a neon-argon Penning mixture of 99.5 mole percent neon and 0.5 mole percent argon according to the invention, respectively. The lamps employed elliptically-shaped discharge vessels having an outer diameter of 18.4 mm, a total length of 68 mm and a wall thickness of 1 mm. The starting gas fill pressure was 100 mbar. The average mercury dose was ˜37 mg. The metal halide salt mixture included sodium, calcium, manganese, thallium, and rare earth iodides at a dosing level of 40 mg. The total of rare earth iodides was 3 mole percent. The lamp was dosed with an oxygen dispenser as disclosed in U.S. Pat. No. 6,362,571, the entire specification of which is incorporated herein by reference.

The electrode dimensions were 8.0 mm×0.7 mm and the inter-electrode distance was 14 mm. The lamps used an ED37 outer bulb with vacuum fill. No protective sleeve was used for these lamps. These lamps were aged on probe-start MH400 W M59 ballasts for 1,000 hours. The starting data on the quartz metal halide lamp ballast for both sets of lamps, made according to the prior art with ArKr⁸⁵ gas and this invention with NeAr gas are listed in Table 1 below:

TABLE 1

| | | Gas | |
|---|---|---|---|
| | | ArKr⁸⁵ | NeAr (99.5%:0.5%) |
| | | Time to start @ −30° C. | Time to start @−30° C. |
| Lamp | antenna | 100 hr, seconds | 100 hr, seconds |
| 400 W | Yes | Can't start | 1.2 s |
| 400 W | Yes | Can't start | 1.2 s |
| 400 W | Yes | Can't start | 1.8 s |
| 400 W | No | | 2.1 s |
| 400 W | No | | 1.9 s |
| 400 W | No | | 2.1 s |

Table 1 shows starting time in the cold and dark box at −30° C. The lamps with ArKr⁸⁵ gas and an antenna couldn't start at −30° C. Thus, the lamps with the same fill gas but without an antenna were not tested. All of the lamps with NeAr (99.5%:0.5%) gas started within 3 seconds. There is no statistical difference between the lamps with and without antenna for the neon-argon gas fill.

### Example 2

Two sets of 400 W CDM lamps of the type shown in FIG. 1 were prepared as described in Example 1, except that the starting gas fill for both sets was Ne:Ar (95%:0.5%); the fill gas pressure was 100 mbar; and the aspect ratio of the discharge vessel was 1.4.

In addition, one set of the lamps were provided with a starting aid in the form of a floating antenna made of Mo. The distance a between the antenna and a discharge electrode was 5 mm.

Starting was evaluated using two types of ballasts, both designed for high pressure mercury vapor lamps. The first ballast was a CWA ballast made by Advance Transformer Co. according to American National Standard ANSI code H33 (OCV of 300v), ballast product number 71A 4091, and the second ballast was a reactor ballast made by MWH, ballast product number 260338.

The lamps without an antenna started at nominal power, but did not start at −10 percent nominal power. The lamps with an antenna started at −10% of the nominal rated power.

The starting data at −10% input voltage @25° C. for the lamps made according this invention (with and without antenna) are listed in Table 2 below:

TABLE 2

| | | | Ballast | | |
|---|---|---|---|---|---|
| | | | CWA HP, ANSI | | Reactor, MWH, |
| | | | H33 71A 4091 | | 260338, 240 V |
| | ANSI | | Time to start (seconds) at −10% | | |
| Lamp | requirement | antenna | input voltage @25° C. | | |
| 1 400 W- | <2 minutes | Yes | 34 | s | 22 s |
| 2 400 W- | <2 minutes | Yes | 15 | s | 7 s |
| 3 400 W- | <2 minutes | Yes | 9 | s | 13 s |
| 4 400 W- | <2 minutes | Yes | 10 | s | 25 s |
| 1 400 W- | <2 minutes | No | 20 | s | Can't start |
| 2 400 W- | <2 minutes | No | 1′36″ | s | Can't start |
| 3 400 W- | <2 minutes | No | 10 | s | Can't start |
| 4 400 W- | <2 minutes | No | 22 | s | Can't start |
| 5 400 W- | <2 minutes | No | 9 | s | Can't start |

Tests were also conducted to show that the lamps with antenna can start in the cold and dark. In accordance with the ANSI requirement, the lamps with antennas were stored in the cold and dark box at −30° C. overnight prior to testing.

The tests were conducted on the same two types of ballasts for high pressure mercury vapour lamps as described above.

Results are shown in Table 3 below.

TABLE 3

| | | | Ballast | | | |
|---|---|---|---|---|---|---|
| | | | CWA HP, ANSI | | Reactor, MWH, | |
| | | | H33 71A 4091 | | 260338, 240 V | |
| | ANSI | | Time to start (sec) at nominal | | | |
| Lamp | retirement | antenna | input voltage @−30° C. | | | |
| 1 400 W- | <2 minutes | Yes | 5.4 | s | 2.7 | s |
| 2 400 W- | <2 minutes | Yes | 20 | s | 14 | s |
| 3 400 W- | <2 minutes | Yes | 4.3 | s | 2.7 | s |
| 4 400 W- | <2 minutes | Yes | 54 | s | 2.1 | s |

Table 4 below lists the light technical data for the tested CDM 400 W lamps of the invention, together with, for comparison, the published data for HPI and HP 400 W lamps. Note that the efficacy for the CDM400 W lamps of the invention is 33% higher than the HPI lamp and 95% higher than the mercury vapour lamp, which means 33% and 95% energy savings when replacing HPI and HP lamps by the CDM400 W lamps of the invention. Moreover, the color rendering index (CRI) for the CDM400 W lamps of the invention is 94 compared to 65 for HPI lamp and 20 for mercury vapour lamp.

TABLE 4

| | | | | | | | | | | | |
|---|---|---|---|---|---|---|---|---|---|---|---|
| ID | n | V | Current | Power | Lumens | Lm/W | CCT | CRI | x | y | MPCD |

With antenna read @ watts

| | | | | | | | | | | | |
|---|---|---|---|---|---|---|---|---|---|---|---|
| invention | 5 | 137.6 | 3.56 | 400 W | 44959 | 112.4 | 3886 | 94.7 | .388 | .389 | 9.8 |
| stdev | | 2.8 | 0.04 | 1.4 | 582 | 1.3 | 67 | 2.0 | .001 | .005 | 3.7 |
| HPI | | | | 400 W | 33600 | 84 | 3800 | 65 | | | |
| 400 W | | | | | | | | | | | |
| HP | | | | 400 W | 21000 | 52.5 | 6500 | 20 | | | |
| 400 W | | | | | | | | | | | |

Thus, in its various embodiments and implementations, the invention discloses a technological advanced CDM lamp that can retrofit and reliably ignite on existing HPI and HP systems. In addition, the lamp of the invention exhibits improved performance over existing HPI and HP lamps, including higher efficacy (>100 lumens per watt, lm/W, which meets or exceeds many of the recent energy regulations), good better colour properties and improved lumen maintenance.

The invention has necessarily been described in terms of a limited number of embodiments. From this description, other embodiments and variations of embodiments will become apparent to those skilled in the art, and are intended to be fully encompassed within the scope of the invention and the appended claims.

1. A ceramic gas discharge metal halide (CDM) lamp (10) comprising:
a ceramic discharge vessel (12) with a central portion (13) enclosing a discharge space (14), and a pair of end portions (15, 16);
a pair of discharge electrodes (17, 18) extending through the respective end portions (15, 16) into the discharge space (14);
an outer glass envelope (19) surrounding the discharge vessel (12), and a metal base (20), the outer glass envelope (19) sealed to the metal base (20) to form a gas-tight enclosure for the discharge vessel (12);
characterized in that the discharge vessel (12) comprises a starting gas mixture of neon and argon, and a chemical fill which includes an oxygen dispenser and no more than about 5 mole percent of strong oxygen binders.

2. The CDM lamp (10) of claim 1 in which the starting gas mixture of neon and argon comprises a Penning mixture of from about 95 to 99.8 mole percent of neon and from about 0.2 to about 5 mole percent of argon.

3. The CDM lamp (10) of claim 1 in which the oxygen dispenser is a calcium oxide (CaO)-impregnated ceramic.

4. The CDM lamp (10) of claim 1 in which the oxygen binder is one or more of the members selected from the group consisting of the rare earth halides, scandium halide and yttrium halide.

5. The CDM lamp (10) of claim 1 in which the oxygen binder is present in the chemical fill in the amount of up to about 5 mole percent.

6. The CDM lamp (10) of claim 5 in which the oxygen binder is present in the chemical fill in the amount of up to about 3 mole percent.

7. The CDM lamp (10) of claim 1 in which the starting gas mixture is present in the discharge vessel (12) at a pressure of from about 40 mbar to 250 mbar.

8. The CDM lamp (10) of claim 7 in which the starting gas mixture is present in the discharge vessel (12) at a pressure of from about 60 mbar to 150 mbar.

9. The CDM lamp (10) of claim 1 in which a passive starting electrode (26) is present outside the discharge vessel (12).

10. The CDM lamp (10) of claim 9 in which the passive starting electrode (26) is located on the outer wall of the discharge vessel (12).

11. The CDM lamp (10) of claim 1 in which the aspect ratio R of the discharge vessel (12) is smaller than 2.

12. The CDM lamp (10) of claim 11 in which the aspect ratio R of the discharge vessel (12) is smaller than 1.5.

13. The CDM lamp (10) of claim 1 in which the distance a between a discharge electrode coil (17a, 18a) and the passive starting electrode (26) is up to about 7 mm.

14. The CDM lamp (10) of claim 1 in which the wall thickness t is up to about 1.2 mM.

15. The CDM lamp (10) of claim 1 in which the distance d between the discharge electrodes (17, 18) is up to about 14 mm.
